(19) United States
(12) Patent Application Publication
(10) Pub. No.: US 2025/0347934 A1
(43) Pub. Date: Nov. 13, 2025

(54) PHASE AND AMPLITUDE TUNING IN A SILICON PHOTONICS CIRCUIT

(71) Applicant: Taiwan Semiconductor Manufacturing Company, Ltd., Hsin-Chu (TW)

(72) Inventors: You-Cheng Lu, Tainan City (TW); Lan-Chou Cho, Hsinchu City (TW); Stefan Rusu, Sunnyvale, CA (US)

(21) Appl. No.: 18/812,471

(22) Filed: Aug. 22, 2024

Related U.S. Application Data
(60) Provisional application No. 63/644,747, filed on May 9, 2024.

(51) Int. Cl. G02F 1/01; G02B 6/293; G02F 1/21; G02F 1/225

(52) U.S. Cl. CPC G02F 1/0123; G02B 6/29338; G02F 1/212; G02F 1/2257; G02F 2201/302; G02F 2202/10; G02F 2203/15; G02F 2203/20

(57) ABSTRACT

A silicon photonics integrated circuit includes a polarization splitting grating coupler (PSGC) configured to receive an optical signal and split the optical signal into two polarization components. The circuit includes a phase controller coupled to the PSGC, and the phase controller is configured to tune the split optical signal such that the two polarization components are in phase. The circuit includes a first and a second photodiode coupled to the phase controller, where the first photodiode receives a first component of the two polarization components and the second photodiode receives a second component of the two polarization components, and the first and second photodiodes converts the first and second components into first and second electrical signals, respectively. The circuit includes an amplitude controller coupled to the first and the second photodiodes, the amplitude controller configured to add the first and the second electrical signals to output a combined electrical signal.

### BACKGROUND

This application claims the benefit of U.S. Provisional App. No. 63/644,747, filed May 9, 2024, which is hereby incorporated by reference in its entirety.

### BACKGROUND

Optical gratings are frequently used to couple light between an optical fiber and a silicon photonics waveguide in a silicon photonics circuit. Due to extremely different dimensions of the optical fiber and the waveguide, direct coupling would incur tremendous light loss. Further, an incoming light to a waveguide is usually in an unknown and arbitrary polarization state, such that a two-dimensional (2D) grating coupler, for example, a polarization splitting grating coupler (PSGC), is needed to provide polarization light in either transverse magnetic (TE) or transverse magnetic (TM) polarization mode from the optical fiber to the waveguide.

For instance, induced stress, imperfections, or temperature changes in the optical fiber may cause random power transfer between the two polarizations (TE and TM) in the fiber. Such random polarization causes power to be delivered unevenly between the polarizations, which would result in considerable loss of signal if only power from one polarization (e.g., TE but not TM) is received by a waveguide in the silicon photonics circuit. As such, a 2D grating coupler such as a PSGC may be used to split a received optical signal from an optical fiber into two orthogonal polarizations and direct the two polarizations to separate waveguides on a silicon photonics integrated circuit. The two separated polarizations are then processed and recombined such that there is no signal loss in phase or in amplitude when converting the optical signals into electrical signals. In this way, issues of polarization incompatibility can be addressed.

However, tuning the phase and the amplitude of the received split optical signals may require optical interference circuits (e.g. Mach-Zehnder interferometer modulators) that increase power consumption requirements while taking up precious space. Therefore, although existing methods and systems for removing polarization incompatibility between an optical fiber and a photonics circuit have been generally adequate for their intended purposes, they have not been entirely satisfactory in every aspect.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion. It is also emphasized that the figures appended illustrate only typical embodiments of this invention and are therefore not to be considered limiting in scope, for the invention may apply equally well to other embodiments. Further, the accompanying figures may implicitly describe features not explicitly described in the detailed description.

FIG. 1 illustrates an optoelectronic system for processing received optical signals in a silicon photonics circuit, according to an embodiment of the present disclosure.

FIG. 2 illustrates an optoelectronic system having phase and amplitude controllers located in the optical path (or portion) of the optoelectronic system, according to an embodiment of the present disclosure.

FIG. 3 illustrates phase and amplitude tuning after splitting an optical signal into two polarization states (TE and TM).

FIGS. 4A-4B illustrate optoelectronic systems having phase controllers located in the optical path (or portion) of the optoelectronic system and amplitude controllers located in the electrical path (or portion) of the optoelectronic system, according to an embodiment of the present disclosure.

FIG. 5 illustrates the optoelectronic system of FIG. 4B, according to another embodiment of the present disclosure.

FIGS. 6A-6B illustrate photodiode configurations according to different embodiments.

FIGS. 7A-7B illustrate optoelectronic systems having phase and amplitude controllers located in the electrical path (or portion) of the optoelectronic system, according to an embodiment of the present disclosure.

FIG. 8 illustrates an optoelectronic system for multi-wavelength design, according to an embodiment of the present disclosure.

FIG. 9 illustrate optoelectronic systems for multi-wavelength design, according to additional embodiments of the present disclosure.

FIGS. 10-11 illustrate photodiode configurations according to additional embodiments.

FIG. 12 illustrate the use of micro ring resonators (MRR) to tune (e.g., drop) operating wavelengths received after splitting input optical signals, according to an embodiment of the present disclosure.

FIG. 13 illustrate the use of micro ring resonators (MRR) to tune (e.g., drop) operating wavelengths received after splitting input optical signals, according to another embodiment of the present disclosure.

FIG. 14 illustrates measuring converted electrical signals in a path of an optoelectronic system.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, when a number or a range of numbers is described with “about,” “approximate,” and the like, the term is intended to encompass numbers that are within a reasonable range considering variations that inherently arise during manufacturing as understood by one of ordinary skill in the art. For example, the number or range of numbers encompasses a reasonable range including the number described, such as within +/−10% of the number described, based on known manufacturing tolerances associated with manufacturing a feature having a characteristic associated with the number. For example, a material layer having a thickness of “about 5 nm” can encompass a dimension range from 4.25 nm to 5.75 nm where manufacturing tolerances associated with depositing the material layer are known to be +/−15% by one of ordinary skill in the art. Further, disclosed dimensions of the different features can implicitly disclose dimension ratios between the different features. Still further, the present disclosure may repeat reference numerals and/or letters in the various examples. This repetition is for the purpose of simplicity and clarity and does not in itself dictate a relationship between the various embodiments and/or configurations discussed.

As light travels in optical fibers, the polarization in the optical fibers can change due to induced stress, movement, or temperature changes. Thus, the light may be transferred between two orthogonal polarizations (TE and TM) at random fluctuations. The optical data that the light carries is transmitted through single mode or multi-mode fiber to produce S and P waves (also known as TE and TM waves to I/O) in the fiber. However, on the receiver side, it is necessary for silicon waveguides of the IC to collect all the data without any phase or amplitude loss. The silicon waveguides have polarization mismatch with the incoming optical signals, which means the waveguides must be ready to receive a matching mode of the incoming optical signals. This process may involve polarization splitting, phase tuning, amplitude tuning, signal recombination, and converting optical to electrical signals.

The present disclosure relates to phase and amplitude tuning to address the polarization mismatch as described above. The phase and amplitude tuning is implemented in an optoelectronic system. The optoelectronic system may include one or more silicon photonics integrated circuits to process and convert optical signals (i.e., light) into electrical signals (i.e., current or voltage). The optoelectronic system includes an optical module for processing optical signals and an electrical module for processing electrical signals. To reduce circuit device footprint and to conserve power consumption requirements, the phase and/or amplitude tuning of split optical signals may be performed in the electrical module, thereby reducing or eliminating the need of large optical interference circuits or other optical tuning circuits in the optical module. To this effect, the present disclosure contemplates generating a feedback control signal in the electrical module (as opposed to in the optical module) to control phase shift in the optical module. Further, amplitude tuning may be performed by an amplitude controller in the electrical module (as opposed to in the optical module) to reduce the size of the optical module. In other embodiments, both phase and amplitude tuning may be performed in the electrical module, thereby completely eliminating the need for any optical interference circuits. Dual-port or multi-port photodiodes (or photodetectors) may also be used to further reduce circuit footprint by eliminating the need of adder circuits in the electrical module.

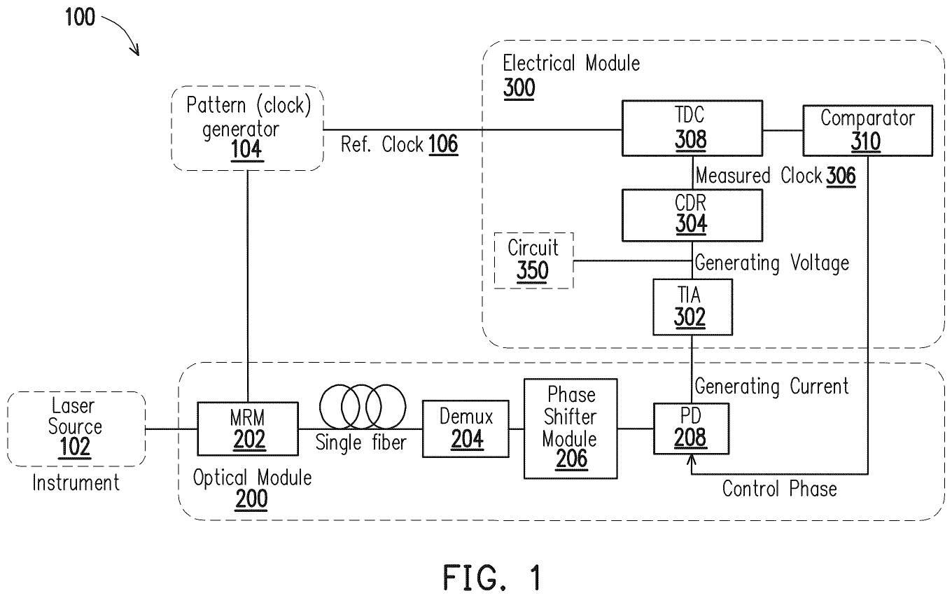

FIG. 1 illustrates an optoelectronic system 100 having an optical module 200 for receiving and processing optical signals and an electrical module 300 for receiving and processing electrical signals. The optoelectronic system 100 includes a phase lock feature using a feedback control signal generated in the electrical module 300 to control optical phase shift in the optical module 200. This phase lock feature may be incorporated in any of the embodiments described later in the present disclosure.

The optoelectronic system 100 may include an optical transceiver that can convert signals between electrical and optical domains. In the present embodiment, the optical transceiver corresponds to and is implemented by the optical module 200. For this reason, the optical module 200 may also be referred to as an optical transceiver 200. The optical module 200 (or optical transceiver 200) may include a transmitter that generates optical signals and a receiver that receives optical signals.

The transmitter may include a laser source 102, a pattern generator 104, and a micro ring modulator (MRM) 202. The laser source 102 and the pattern generator 104 are shown to be separate instruments outside of the optical module 200; however, they may also be considered part of a transmitter portion of the optical module 200. The MRM 202 is doped and includes a ring waveguide portion coupled to a bus waveguide portion. The bus waveguide portion of the MRM 202 receives an input laser light from the laser source 102, and the ring waveguide portion of the MRM 202 receives an input electrical signal from the pattern generator 104 (also known as a pulse generator). The input electrical signal is used to modulate the input laser light, which in turn causes the MRM 202 to encode the electrical signal into an optical signal. The input electrical signal may be in the form of a modulated input voltage. The modulated input voltage provides bias to the ring waveguide portion of the MRM 202, which causes the input laser light traveling in the bus waveguide portion of the MRM 202 to be modulated into an optical signal. The bus waveguide portion of the MRM 202 feeds into a fiber optic cable (e.g., single fiber) which then further carries the optical signal to a receiver.

The receiver may include a demultiplexer (demux) 204, a phase shifter module 206, and a photodiode module (PD) 208. Although not shown in FIG. 1, in other embodiments that follow, the optical signal may first be split into two polarizations (e.g., TE and TM modes) before it is received at the demux 204. For example, the optical signal is split to separately tune and compensate for polarization mismatch.

At the receiver end, the demux 204 routes a received optical signal to a selected output line out of multiple possible output lines (for multi-wavelength design). The optical signal is then routed into the phase shifter module 206 where phase and/or amplitude of the optical signal is tuned for maximum recovery of signal data. The phase shifter module 206 may include one or more optical interference circuits. An optical interference circuit may refer to an electro-optic modulator configured to tune optical phase or amplitude. For example, the optical interference circuit may include phase and/or amplitude modulators that use one or more Mach-Zehnder interferometers (MZIs). Such optical interference circuit may also be referred to as an optical phase controller and/or an optical amplitude controller. In one example, the phase shifter module includes two MZIs, one for tuning phase and one for tuning amplitude. Thereafter, the tuned signal from the phase shifter module 206 is received by the PD module 208 that turns the optical signal into electrical signals such as by generating current.

The electrical signals are received and further processed in the electrical module 300. The electrical module 300 may include a transimpedance amplifier (TIA) module 302, a clock data recovery (CDR) circuit 304, a time-to-digital (TDC) converter 308, and a comparator 310. The electrical module 300 may further include a circuit 350, which receives recovered electrical signals (e.g., voltage or current).

As shown, the generated current from the PD module 208 is received by a transimpedance amplifier (TIA) module 302. The TIA module 302 converts the received current into voltage. The generated voltage may then be received by a circuit 350, where data in the transmitted optical signal is now recovered as an electrical data stream. Further, a measured clock 306 of the generated voltage may be recovered by the CDR circuit 304. The measured clock 306 is compared to a reference clock 106. The reference clock 106 is generated by the pattern generator 104 when generating the modulated electrical signal to bias the MRM 202. In this way, the pattern generator 104 also functions as a clock generator. Both the reference clock 106 and the measured clock 306 may be received by the TDC 308, which measures time and/or phase differences between the two clocks and converts it into digital output. The comparator 310 may work in tandem with the TDC to compare and determine a phase offset between the measured clock 306 and the reference clock 106. Based on the comparison, a feedback signal is sent to the phase shifter module 206 to control phase shift. For example, a phase difference of 30 degrees in time is calculated to require a control voltage of 2 volts to be applied to the phase shifter module 206. The control voltage may be applied to bias one or more optical phase controllers and/or optical amplitude controllers to provide necessary phase shift. Notably, the feedback signal forms a phase control loop circuit that can be used to lock a desired phase such that any movement of the fiber that causes phase change is compensated. As shown, the feedback signal is an electrical signal generated and sent from the electrical module 300 to the phase shifter module 206 in the optical module 200. In this way, phase shift control is delegated to the electrical module 300 instead of implementing additional optical tuning circuits in the optical module 200.

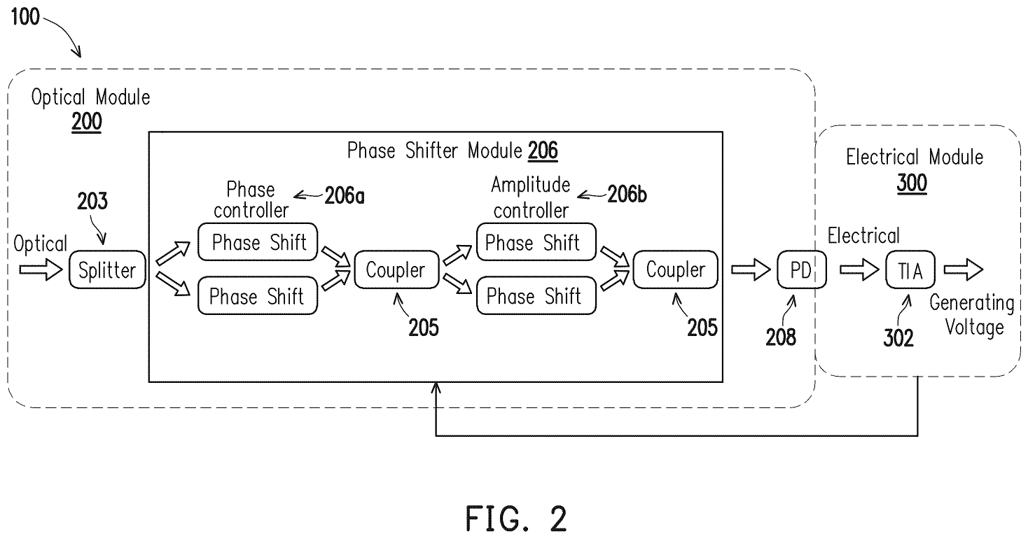

FIG. 2 illustrates an optoelectronic system 100 having phase and amplitude controllers 206a and 206b located in the optical path (or portion) of the optoelectronic system 100, according to an embodiment of the present disclosure. Similar features described in the optoelectronic system 100 of FIG. 1 may equally apply to FIG. 2.

As shown, optical signals travel through an optical path (or portion) of the optoelectronic system, which is implemented by the optical module 200. The optical module 200 includes a splitter 203 (or a beamsplitter 203), a phase shifter module 206, a PD module 208, and couplers 205 between optical components. The phase shifter module 206 further includes a phase controller 206a and an amplitude controller 206b.

As shown, an optical signal from an optic fiber is received by a splitter 203 (e.g., PSGC). The splitter 203 splits the optical signal into two components, i.e., a TE and a TM component. In an embodiment, the TM component is rotated to the TE mode and the light is processed in two parallel paths both in the TE mode. In this embodiment, the silicon waveguide of the silicon photonic IC is configured to receive TE modes. In another embodiment, the TE component is rotated to the TM mode and the light is processed in two parallel paths both in the TM mode. In this embodiment, the silicon waveguide of the silicon photonic IC is configured to receive TM modes. In either case, the phase controller 206a (e.g., an optical interference circuit) tunes the phase of optical signal in one or both of the waveguide paths to account for any mismatch of phase between the signals in the two paths. For example, the phase controller 206a is implemented by an MZI circuit, and a heat or a bias voltage is applied to the MZI circuit to perform phase shift. As a result, the phase of the two split signals are tuned to be aligned in the parallel paths. The tuning of the phase shift is based on a feedback signal from the electrical module 300, according to the feedback phase lock feature previously described. Each path are then coupled back together by a coupler 205 (e.g., a 3 dB coupler) then split back into two paths into an amplitude controller 206b (e.g., another optical interference circuit). The amplitude controller 206b may be another phase shifter adjusted such that the signals now in-phase between the waveguides are coupled into a single output waveguide. For example, the amplitude controller 206b is implemented by a second MZI circuit, and a heat or a bias voltage is applied to the second MZI circuit to perform phase shift. As a result, all optical signal from a first waveguide path is shifted and coupled into a second waveguide path (e.g., through constructive optical interference). The tuning of the phase shift is also based on a feedback signal from the electrical module 300, according to the feedback phase lock feature previously described. Each path are then coupled back together by another coupler 205 (e.g., a 3 dB coupler), and then to a PD module 208 where the combined and tuned optical signals are converted into an electrical signal (e.g., current).

The electrical signal travels through an electrical path (or portion) of the optoelectronic system 100 implemented by the electrical module 300. The electrical module 300 includes a TIA module 302 that amplifies and converts the electrical signal into voltage. Although not shown, the voltage may then be used to bias other portions of an integrated circuit (e.g., circuit 350).

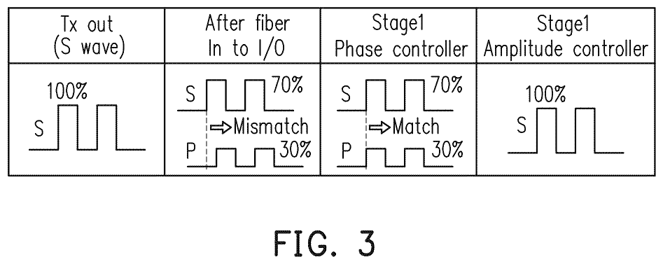

FIG. 3 illustrates phase and amplitude tuning after splitting an optical signal into two polarization states (TE and TM). In reference to FIG. 2, the phase and amplitude tuning may be performed by the phase and amplitude controllers 206a and 206b of the phase shifter module 206.

As shown in FIG. 3, an optical signal may be transmitted by a transmitter (Tx) in the form of an S wave (also known as TE wave). In this case, the initially transmitted optical signal is a 100% S wave (i.e., 100% TE wave). However, as the optical signal travels through a fiber optic cable, the TE wave may experience random fluctuations due to stress on the fiber optic cable, resulting in the optical signal to now carry both S and P waves at different phases and/or at different intensities (i.e., the optical signal is no longer an S wave at 100% intensity). To address signal loss due to these polarization fluctuations, the optical signal is first split (e.g., by splitter 203) into the two polarization components. For example, and as shown, the split polarization components includes an S wave (i.e., TE wave) at 70% intensity and a P wave (i.e., TM wave) at 30% intensity, where the two split components have a phase mismatch. As such, during a first stage, a phase controller (e.g., phase controller 206a) may tune the split optical signals to match the phase of the two polarization components. For example, and as shown, the S wave (i.e., TE wave) at 70% intensity and the P wave (i.e., TM wave) at 30% intensity are tuned to be in phase through phase shifting by the phase controller. (Note that although not explicitly shown, the P wave (i.e., TM wave) at 30% intensity may be converted into a S wave (i.e., TE wave) before matching phase by the phase controller.) Thereafter, during a second stage, an amplitude controller (e.g., amplitude controller 206b) may tune the phase-matched signals together into a combined optical signal (e.g., through constructive optical interference). For example, and as shown, the combined signal is now a recovered S wave at 100% intensity.

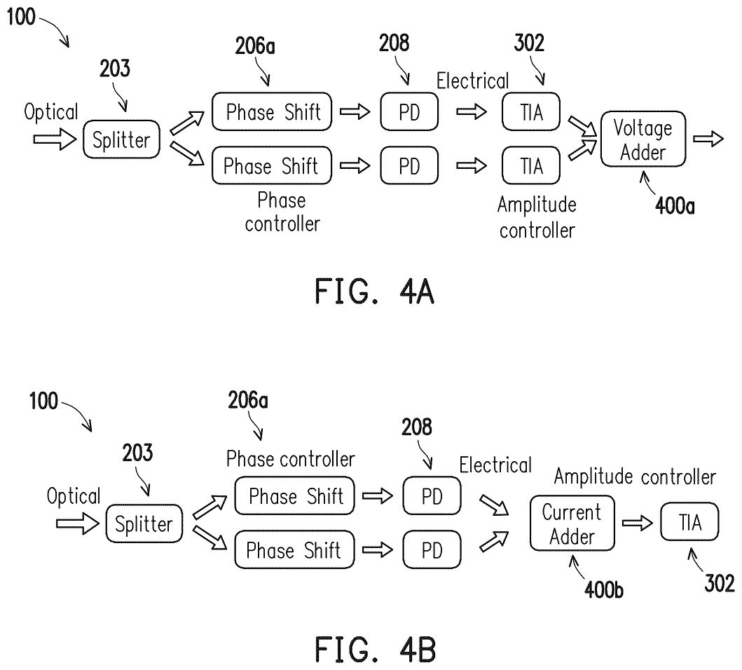

FIGS. 4A-4B illustrate optoelectronic systems 100 having phase controllers 206a located in the optical path (or portion) of the optoelectronic system 100 and amplitude controllers located in the electrical path (or portion) of the optoelectronic system 100, according to an embodiment of the present disclosure. When compared to the optoelectronic system 100 shown in FIG. 2, FIGS. 4A-4B illustrate the elimination of the amplitude controller 206b in the optical path (i.e., there is no optical interference circuit for tuning amplitude). This reduces optical footprint and power consumption. Instead, amplitude is tuned or controlled in the electrical path (or portion) of the optoelectronic system 100 through TIA modules 302 and voltage/current adders 400a and 400b. Note that phase is still tuned in the optical path through an optical interference circuit (e.g., phase controller 206a implementing MZI). However, the output of the phase-matched signals are individually received by respective PD modules 208 (e.g., single port PDs). The respective PD modules 208 then converts the respective phase shifted optical signals into electrical signals in the form of currents.

In the optoelectronic system 100 of FIG. 4A, the amplitude is controlled by converting the currents into voltages and adding the voltages together in a voltage adder 400a to output a combined voltage. In this case, the two TIA modules 302 and the voltage adder 400a may collectively form an amplitude controller. The amplitude controller first converts the individual currents from the two PD modules 208 into individual voltages by the two TIA modules 302, then the TIA modules 302 may adjust the voltages by providing necessary gains, then the voltage adder 400a adds together the adjusted voltages. For example, a first TIA module 302 converts current of a first electrical signal to a first voltage, a second TIA module 302 converts current of a second electrical signal to a second voltage. The first and second TIA modules 302 may further amplify the first and second voltages at desired gains. Then after amplification, the resulting first and second voltages are added together by the voltage adder 400a. Note that in some embodiments (not shown), the PD modules 208 directly output voltages (e.g., in photovoltaic mode), and the voltages are then combined with a voltage adder 400a without the TIA modules 302.

In the optoelectronic system 100 of FIG. 4B, the amplitude is controlled by adding the currents together in a current adder 400b and converting the combined current into a combined voltage. In this case, the current adder 400b and the single TIA module 302 may collectively form an amplitude controller. The amplitude controller first adds the individual currents from the two PD modules 208 into a combined current, then the TIA module 302 converts the combined current into a voltage, and the TIA module 302 may adjust the voltage by providing necessary gains. For example, a current adder 400b first adds a first current signal and a second current signal together by a current adder 400b. Then, a TIA module 302 converts the combined current into a combined voltage. Then, the TIA module 302 may further amplify the combined voltage at desired gains.

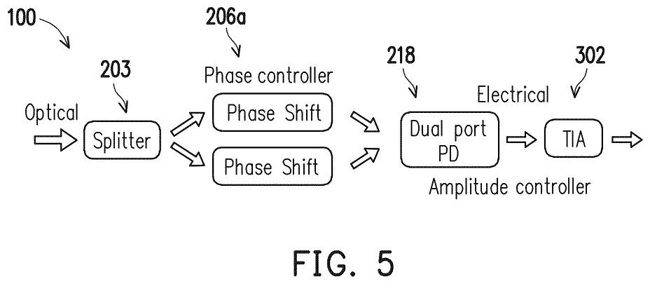

FIG. 5 illustrates the optoelectronic system 100 of FIG. 4B, according to another embodiment of the present disclosure. FIG. 5 illustrate that a dual-port PD module 218 can be used to combine split current signals without the need of a current adder (e.g., current adder 400b). As shown, split optical signals from a splitter 203 (e.g., PSGC), after going through phase shift in a phase controller 206a can then be recombined through a dual-port PD module 218, where the two optical signals are received at two input ports of the dual-port PD module 218, and the dual-port PD module 218 converts the two optical signals to output a single combined current. In this case, the dual-port PD module 218 and the single TIA module 302 may collectively form an amplitude controller. In other respects, the optoelectronic system 100 in FIG. 5 is similar to FIG. 4B.

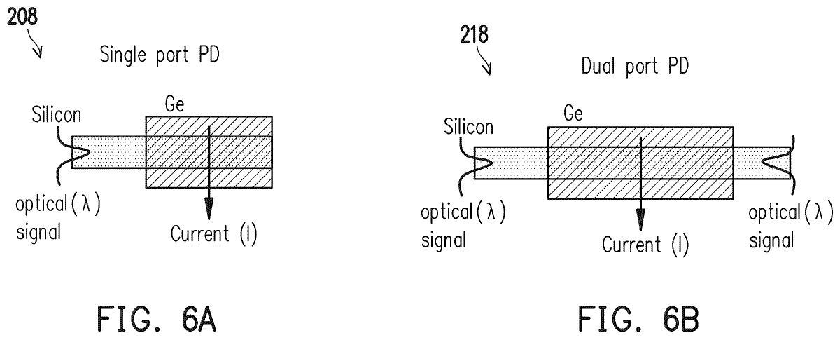

FIGS. 6A-6B illustrate photodiode configurations according to different embodiments. FIG. 6A illustrates a single-port photodiode (e.g., a single PD module 208 previously described). In the present embodiment, the single-port photodiode includes a doped silicon waveguide for receiving an optical signal at a wavelength λ and a germanium (Ge) layer over the doped silicon waveguide. When the germanium layer is biased, the germanium layer converts a received optical signal into an electrical current (I). For example, the silicon waveguide receives a first component of two polarization components (e.g., TE optical wave portion) at a wavelength λ, then after the germanium layer is biased, the first component is converted into an electrical current that is outputted from the single-port photodiode.

FIG. 6B illustrates a dual-port photodiode (e.g., a dual-port PD module 218 previously described). In the present embodiment, the dual-port photodiode includes a doped silicon waveguide for receiving a first optical signal at a wavelength λ and a second optical signal at the wavelength λ. The dual-port photodiode further includes at germanium (Ge) layer over the doped silicon waveguide and between two input ends of the doped silicon waveguide. When the germanium layer is biased, the germanium layer converts received first and second optical signals into a combined electrical current (I). For example, the silicon waveguide at one input end receives a first polarization component (e.g., TE optical wave portion) at a wavelength λ, and at another input end receives a second polarization component (e.g., TM optical wave portion) at the wavelength λ, then after the germanium layer is biased, the first and second components are collectively converted into a combined electrical current that is outputted from the dual-port photodiode.

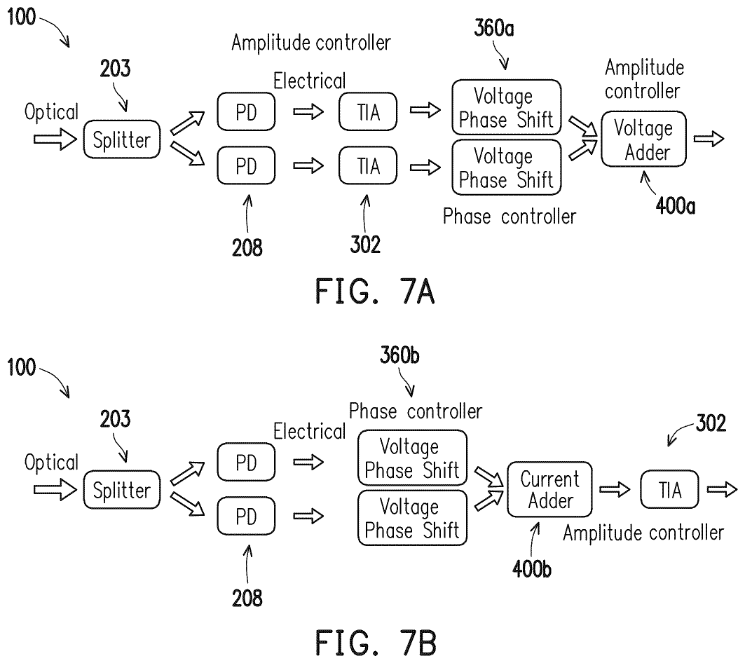

FIGS. 7A-7B illustrate optoelectronic systems 100 having phase and amplitude controllers located in the electrical path (or portion) of the optoelectronic system, according to an embodiment of the present disclosure. When compared to the optoelectronic system 100 shown in FIGS. 4A-4B, FIGS. 7A-7B further illustrate the elimination of the phase controller 206a in the optical path (i.e., there is no optical interference circuit for tuning phase). In this case, no optical interference circuits are used for tuning phase and/or for tuning amplitude. Instead, both the phase and amplitude tuning position is modified to be in the electrical circuit portion, thus it becomes easier to control the entire system.

In the embodiment shown in FIG. 7A, split optical signals are directly received at respective PD modules 208 (or a dual-port PD module 218) and the output currents are converted into voltage by respective TIA modules 302 where amplitude is tuned by controlling voltage gain. The respective converted voltages are then received by voltage phase shifters 360a for phase tuning and added together by a voltage adder 400a for a second portion of amplitude tuning. In this case, the amplitude controller may include the two TIA modules 302 and the voltage adder 400a, and the phase controller may include the two voltage phase shifters 360a.

In the embodiment shown in FIG. 7B, split optical signals are directly received at respective PD modules 208 (or a dual-port PD module 218) and the output currents are then received by current phase shifters 360b for phase tuning and added together by a current adder 400b. The combined current is then converted into voltage by a TIA module 302 for amplitude tuning. In this case, the amplitude controller may include the current adder 400b and the TIA module 302, and the phase controller may include the two current phase shifters 360b.

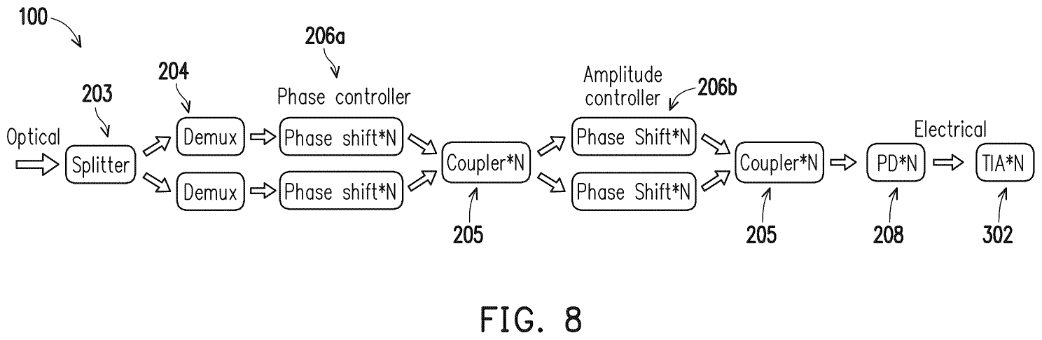

FIG. 8 illustrates an optoelectronic system 100 for multi-wavelength design, according to an embodiment of the present disclosure. The optoelectronic system 100 may be an optical-to-electrical transceiver (TRX) system for receiving a multi-wavelength optical signal. In another embodiment, the TRX system may receive multiple optical signals at multiple different wavelengths. In either case, for each individual wavelength instance N, there is a corresponding number of phase shifters for the phase controller 206a, a corresponding number of phase shifters for the amplitude controller 206b, a corresponding number of couplers 205, a corresponding number of PD modules 208, and a corresponding number of TIA modules 302. In this way, the multiple phase and amplitude shifters can effectively and independently manage each individual wavelength instance N.

Since there are multiple wavelengths to be managed, demuxers 204 are used to direct split signals to multiple possible outputs for phase and amplitude tunning corresponding to the individual wavelengths. As shown, a first demux 204 parses out multiple input wavelength instances N in a first split optical path for first polarization components. A second demux 204 parses out multiple input wavelength instances N in a second split optical path for second polarization components. Each of the first and second demuxers 204 selectively couples a specific input wavelength instance N from among multiple input wavelength instances to a corresponding instance path. In other respects, the optoelectronic system 100 in FIG. 8 is similar to the one shown in FIG. 2.

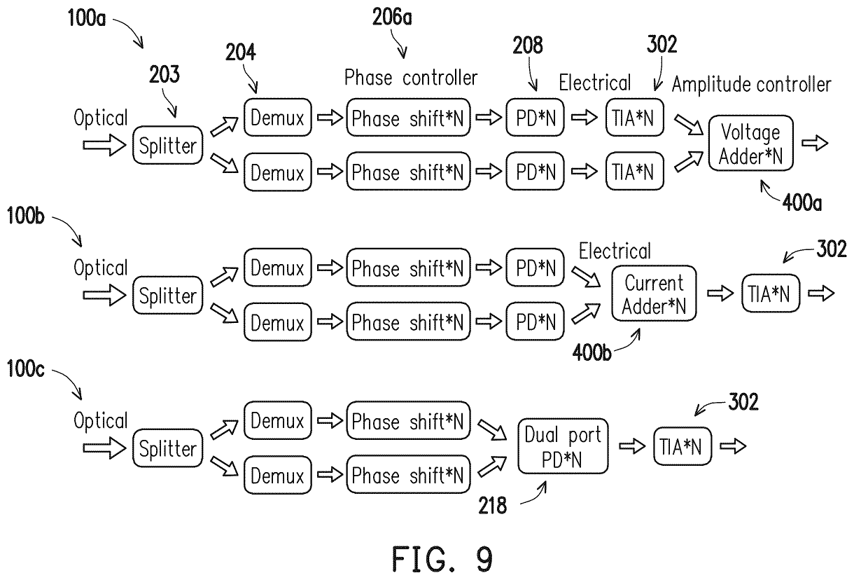

FIG. 9 illustrate optoelectronic systems 100a-100c for multi-wavelength design, according to additional embodiments of the present disclosure. The optoelectronic systems 100a-100c incorporate demuxers 204 to tune and process individual wavelength instances N, similar to the optoelectronic system 100 of FIG. 8. The difference is that amplitude tuning is performed in the electrical path (or portion) instead of the optical path (or portion) of the respective optoelectronic systems 100a-100c. In this respect, the optoelectronic system 100a may correspond to the optoelectronic system 100 of FIG. 4A; the optoelectronic system 100b may correspond to the optoelectronic system 100 of FIG. 4B; and the optoelectronic system 100c may correspond to the optoelectronic system 100 of FIG. 5.

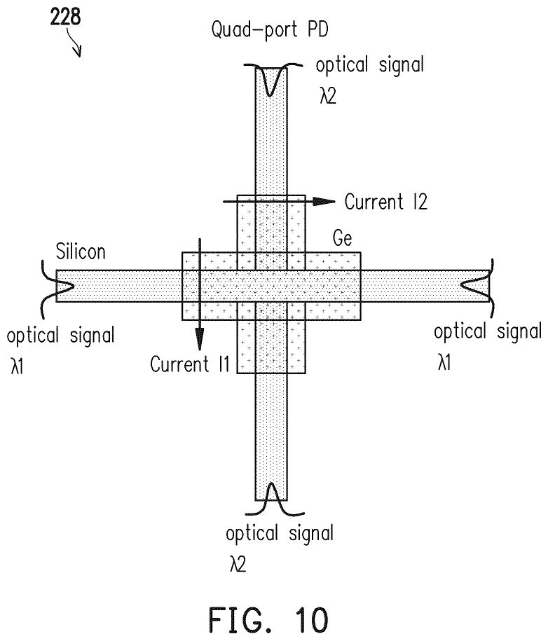

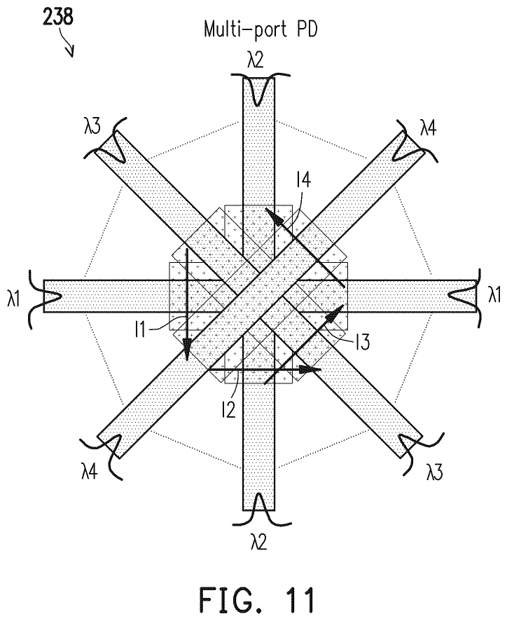

FIGS. 10-11 illustrate photodiode configurations according to additional embodiments. FIG. 10 illustrates a quad-port photodiode (also referred to as a quad-port PD module 228). The quad-port PD module 228 may consist of two dual-port PD modules 218 previously described. In the present embodiment, the quad-port PD module 228 includes a first doped silicon waveguide for receiving an optical signal at a wavelength λ1; and a first germanium (Ge) layer over the first doped silicon waveguide and between two input ends of the first doped silicon waveguide. The quad-port PD module 228 further includes a second doped silicon waveguide for receiving an optical signal at a wavelength λ2; and a second germanium (Ge) layer over the second doped silicon waveguide and between two input ends of the second doped silicon waveguide. The first and second doped silicon waveguides and Ge layers may intersect each other in a perpendicular manner as shown (e.g., waveguide ends are equidistant from each other in a radial manner).

When the respective germanium layers are biased, the germanium layers convert the received optical signals at wavelength λ1 and at wavelength λ2 into electrical currents I1 and I2, respectively. For example, the first silicon waveguide at one input end receives a first polarization component (e.g., TE optical wave portion) at a wavelength λ1, and at another input end receives a second polarization component (e.g., TM optical wave portion) at the wavelength λ1, then after the first germanium layer is biased, the first and second components are collectively converted into a combined electrical current Il that is outputted from the quad-port PD module 228.

Simultaneously, the second silicon waveguide at one input end receives a first polarization component (e.g., TE optical wave portion) at a wavelength λ2, and at another input end receives a second polarization component (e.g., TM optical wave portion) at the wavelength λ2, then after the second germanium layer is biased, the first and second components are collectively converted into a combined electrical current I2 that is outputted from the quad-port PD module 228.

For a quad-port PD module 228, there are 4 input ports to receive input optical signals (e.g., at wavelengths λ1 and λ2) and 2 output ports to output combined currents (e.g., I1 and I2). Each output port outputs combined current signals of two input optical signals.

FIG. 11 illustrates a multi-port photodiode (also referred to as a multi-port PD module 238). The multi-port PD module 238 may consist of more than two dual-port PD modules 218 previously described (e.g., four is shown in the present embodiment). For example, the multi-port PD module 238 includes a first doped silicon waveguide for receiving an optical signal at a wavelength λ1; and a first germanium (Ge) layer over the first doped silicon waveguide and between two input ends of the first doped silicon waveguide. The multi-port PD module 238 further includes a second doped silicon waveguide for receiving an optical signal at a wavelength λ2; and a second germanium (Ge) layer over the second doped silicon waveguide and between two input ends of the second doped silicon waveguide. The multi-port PD module 238 further includes a third doped silicon waveguide for receiving an optical signal at a wavelength λ3; and a third germanium (Ge) layer over the third doped silicon waveguide and between two input ends of the third doped silicon waveguide. The multi-port PD module 238 further includes a fourth doped silicon waveguide for receiving an optical signal at a wavelength λ4; and a fourth germanium (Ge) layer over the fourth doped silicon waveguide and between two input ends of the fourth doped silicon waveguide. The doped silicon waveguides and Ge layers may intersect each other in a perpendicular manner as shown (e.g., waveguide ends are equidistant from each other in a radial manner).

When the respective germanium layers are biased, the germanium layers convert the received optical signals at wavelengths λ1, λ2, λ3, and λ4 into electrical currents I1, I2, I3, and I4 respectively. For example, the first silicon waveguide at one input end receives a first polarization component (e.g., TE optical wave portion) at a wavelength λ1, and at another input end receives a second polarization component (e.g., TM optical wave portion) at the wavelength λ1, then after the first germanium layer is biased, the first and second components are collectively converted into a combined electrical current I1 that is outputted from the quad-port PD module 228.

Simultaneously, the second silicon waveguide at one input end receives a first polarization component (e.g., TE optical wave portion) at a wavelength λ2, and at another input end receives a second polarization component (e.g., TM optical wave portion) at the wavelength λ2, then after the second germanium layer is biased, the first and second components are collectively converted into a combined electrical current I2 that is outputted from the multi-port PD module 238.

Simultaneously, the third silicon waveguide at one input end receives a first polarization component (e.g., TE optical wave portion) at a wavelength λ3, and at another input end receives a second polarization component (e.g., TM optical wave portion) at the wavelength λ3, then after the third germanium layer is biased, the first and second components are collectively converted into a combined electrical current I3 that is outputted from the multi-port PD module 238.

Simultaneously, the fourth silicon waveguide at one input end receives a first polarization component (e.g., TE optical wave portion) at a wavelength λ4, and at another input end receives a second polarization component (e.g., TM optical wave portion) at the wavelength λ4, then after the fourth germanium layer is biased, the first and second components are collectively converted into a combined electrical current I4 that is outputted from the multi-port PD module 238.

For a multi-port PD module 238, as an example, there are 8 input ports to receive input optical signals (e.g., at wavelengths λ1, λ2, λ3, and λ2) and 4 output ports to output combined currents (e.g., I1, I2, I3, and I4). Each of the 4 output ports outputs combined current signals of 2 of the 8 input optical signals. Note that the number of input ports is not limited to 8. As manufacturing techniques evolve, the number of ports can be 16, 32 or more.

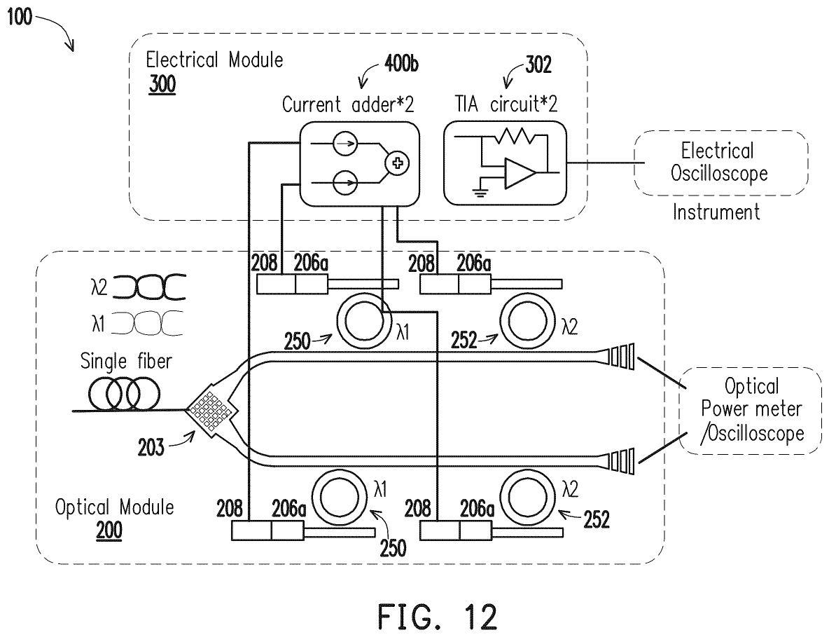

FIG. 12 illustrate the use of micro ring resonators (MRRs) to tune (e.g., drop) operating wavelengths received after splitting input optical signals, according to an embodiment of the present disclosure. As shown, a first operating wavelength λ1 and a second operating wavelength λ2 may be independently tuned by respective sets of MRRs, each set of MRRs include two MRRs each used for tuning a split optical signal by the splitter 203. The MRRs may resemble MRMs (e.g., MRM 202) except that the MRRs are not doped.

As an example, a first set of MRRs 250 are used to tune a first operating wavelength λ1 and a second set of MRRs 252 are used to tune a second operating wavelength. First, a splitter 203 splits an incoming optical signal into a first polarization component transmitting through a first split bus wave guide and a second polarization component transmitting through a second split bus wave guide. For the first set of MRRs 250, a first MRR 250 couples to the first split bus waveguide to tune (e.g., drop) the first polarization component to the first operating wavelength λ1; a second MRR 250 couples to the second split bus waveguide to tune (e.g., drop) the second polarization component to the first operating wavelength λ1. Likewise, for the second set of MRRs 252, a first MRR 252 couples to the first split bus waveguide to tune (e.g., drop) the first polarization component to the second operating wavelength λ2; a second MRR 252 couples to the second split bus waveguide to tune (e.g., drop) the second polarization component to the second operating wavelength λ2. Thereafter, the respective tuned optical signals at the respective operating wavelengths λ1 and λ2 are guided into respective active waveguide paths, then to respective phase controllers 206a, then to respective PD modules 208, current adders 400b, TIA modules 302, etc. Note that optical and electrical instruments such as power meters and oscilloscopes may be inserted into respective optical or electrical paths for measuring optical and/or electrical parameters. These instruments may be used for better signal conditioning of wavelength, phase, and amplitude tuning.

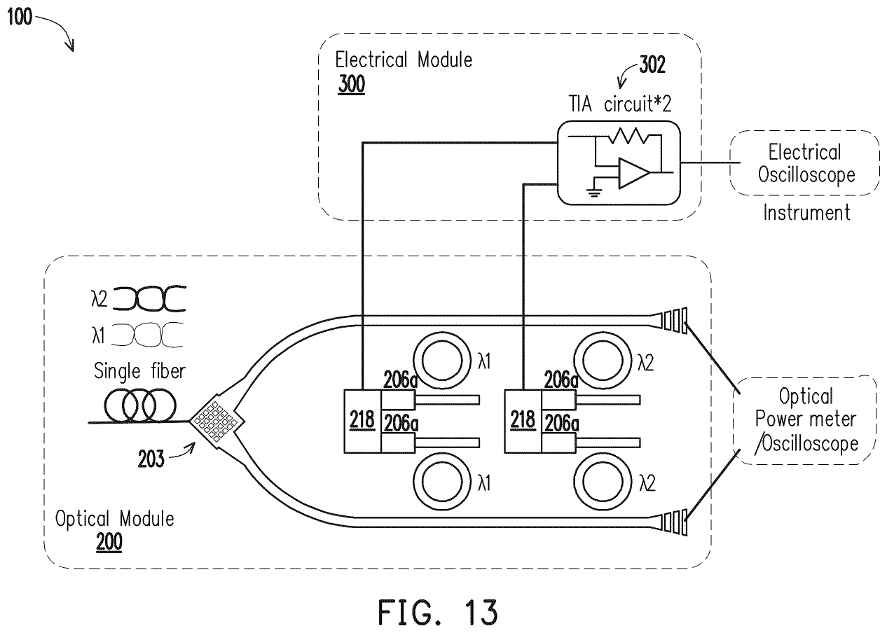

FIG. 13 illustrate the use of micro ring resonators (MRR) to tune (e.g., drop) operating wavelengths received after splitting input optical signals, according to another embodiment of the present disclosure. FIG. 13 resembles FIG. 12, and the similar features will not be described again for the sake of brevity. The difference is that the current adders 400b are eliminated by incorporating dual-port PD modules 218. As shown, the output of the respective dual-port PD modules 218 connects directly to TIA modules 302. This is because the dual-port PD modules 218 can replace the current adders 400b by converting respective split optical components into combined currents. In this way, there is less circuit footprint in both the optical circuit (e.g., optical module 200) and electrical circuit (e.g., electrical module 300) portion of the transceiver system.

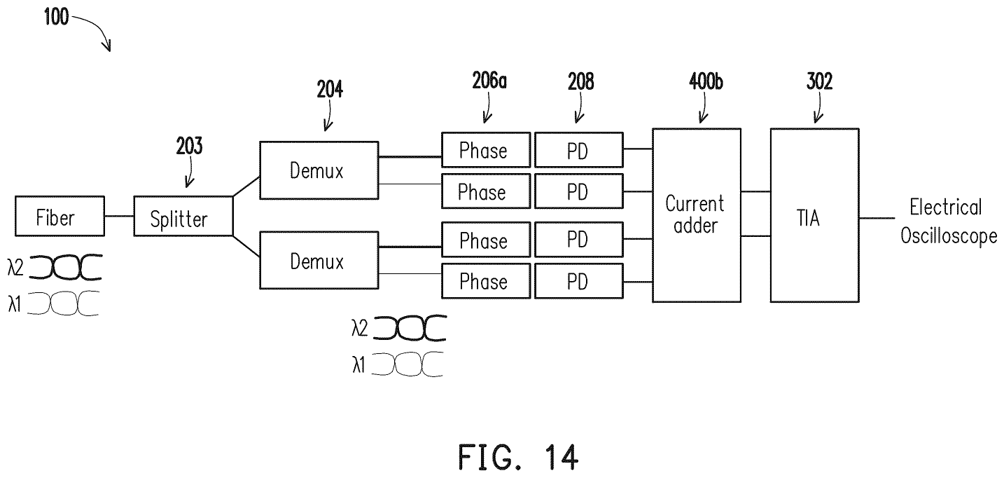

FIG. 14 illustrates measuring converted electrical signals in a path of an optoelectronic system 100. The optoelectronic system 100 include features previously described and is briefly summarized below as another example embodiment. The optoelectronic system 100 illustrates a multi-wavelength system with an optical signal having operating wavelengths λ1 and λ2 split into two polarizations by a splitter 203 (TE and TM, where TM may be then rotated into TE). Each polarization path includes split optical signals each having both wavelengths λ1 and λ2. The split optical signal goes through respective demuxers 204 and each respective optical signal operating at respective wavelengths λ1 and λ2 goes through phase shift in respective phase controllers 206a for phase tuning to match phase between split signals. Thereafter, the resulting tuned split signals are transmitted to respective PD modules 208 to convert optical signals into currents. The currents are added together by a current adder(s) 400b and converted into respective combined amplitude-tuned voltages for wavelengths λ1 and for λ2 by TIA module(s) 302. An electrical oscilloscope may be coupled to the TIA module(s) 302 to measure signal performance where a maximum eye width can be obtained when there is phase match. Depending on the signal measurements, phase shift parameters may be adjusted in the phase controllers 206a such as by a feedback control signal generated in the electrical module 300 according to the phase lock feature of FIG. 1.

Although not limiting, the present disclosure offers advantages for tuning phase and amplitude to compensate for polarization mismatch in an optoelectronic system having electrical and optical circuit portions. One example advantage is to generate a phase-lock feedback control signal in the electrical circuit portion and using it as a control input to optical phase shifters in the optical circuit portion. Another example advantage is to reduce optical circuit footprint by performing amplitude tuning in the electrical circuit portion of an optoelectronic system, such as through transimpedance amplifiers and voltage or current adders. Another example advantage is to further reduce optical circuit footprint by performing phase tuning in the electrical circuit portion of the optoelectronic system. Another example advantage is to use dual-or multi-port photodiodes to further reduce both optical and electrical circuit footprint.

One aspect of the present disclosure pertains to a silicon photonics integrated circuit. The circuit includes a polarization splitting grating coupler (PSGC) configured to receive an optical signal and split the optical signal into two polarization components; a phase controller coupled to the PSGC, the phase controller configured to tune the split optical signal such that the two polarization components are in phase; a first and a second photodiode coupled to the phase controller, where the first photodiode receives a first component of the two polarization components and the second photodiode receives a second component of the two polarization components, and the first and second photodiodes converts the first and second components into first and second electrical signals, respectively; and an amplitude controller coupled to the first and the second photodiodes, the amplitude controller configured to add the first and the second electrical signals to output a combined electrical signal.

In an embodiment, the circuit further includes a feedback circuit, the feedback circuit having: a pulse generator to provide a reference clock of the optical signal; a clock data recovery circuit to recover a clock of the combined electrical signal; and a comparator coupled to the phase controller, the comparator configured to compare the clock of the combined electrical signal with the reference clock. The comparator transmits a control signal to the phase controller to control the tuning of the split optical signal based on the comparison.

In an embodiment, the two polarization components include a transverse electric (TE) component and a transverse magnetic (TM) component, and the TM component is converted into a second TE component before the phase controller tunes the split optical signal.

In an embodiment, the phase controller is implemented by an optical interference circuit that use one or more Mach-Zehnder interferometers (MZIs).

In an embodiment, the first and second electrical signals are first and second electrical currents, and the amplitude controller includes: a current adder that adds the first and second electrical currents to output a combined current; and a transimpedance amplifier to convert the combined current into a combined voltage.

In an embodiment, the first and second electrical signals are first and second electrical currents, and the amplitude controller includes: a first and a second transimpedance amplifier to convert the first and the second electrical currents into a first and a second voltage; and a voltage adder that adds the first and second voltages to output a combined voltage.

In an embodiment, the circuit further includes a first micro ring resonator (MRR) coupled between the PSGC and the phase controller, where the first MRR receives the first component of the two polarization components to tune the first component to a first operating wavelength; and a second MRR coupled between the PSGC and the phase controller, where the second MRR receives the second component of the two polarization components to tune the second component to the first operating wavelength. The first photodiode receives the first component of the two polarization components at the first operating wavelength, and the second photodiode receives the second component of the two polarization components at the first operating wavelength.

In a further embodiment, the phase controller is a first phase controller, the circuit further includes a second phase controller coupled to the PSGC, the second phase controller also configured to tune the split optical signal such that the two polarization components are in phase; a third micro ring resonator (MRR) coupled between the PSGC and the second phase controller, where the third MRR receives the first component of the two polarization components to tune the first component of the split polarization to a second operating wavelength; and a fourth MRR coupled between the PSGC and the second phase controller, where the fourth MRR receives the second component of the two polarization components to tune the second component of the two polarization components to the second operating wavelength, where the first and the second operating wavelengths are different.

In a further embodiment, the circuit further includes a third and a fourth photodiode coupled to the second phase controller, where the third photodiode receives the first component of the two polarization components at the second operating wavelength and the fourth photodiode receives the second component of the two polarization components at the second operating wavelength, and the third and fourth photodiodes converts the first and second components at the second operating wavelength into third and fourth electrical signals, respectively.

In an embodiment, the first photodiode is a single-port photodiode, and the first photodiode includes: a first doped silicon waveguide for receiving the first component of the two polarization components; and a first germanium layer over the first doped silicon waveguide, where when the first germanium layer is biased, the first germanium layer converts the first component of the two polarization components into the first electrical signal.

In a further embodiment, the second photodiode is a single-port photodiode, and the second photodiode includes: a second doped silicon waveguide for receiving the second component of the two polarization components; and a second germanium layer over the second doped silicon waveguide, where when the second germanium layer is biased, the second germanium layer converts the second component of the two polarization components into the second electrical signal.

Another aspect of the present disclosure pertains to a silicon photonics integrated circuit. The circuit includes an optical component having: a beamsplitter configured split an optical signal into a first component and a second component, a phase shifter module configured to tune a phase mismatch between the first and the second components of the optical signal, thereby forming a phase-matched optical signal, and a photodiode module configured to convert the phase-matched optical signal into an electrical signal; and an electrical component having: a clock data recovery module configured to recover a measured clock of the electrical signal, and a comparator coupled to the clock data recovery module, the comparator compares the recovered measured clock with a reference clock to generate a control signal feeding back to the phase shifter module.

In an embodiment, the control signal changes an input bias voltage of the phase shifter module. In an embodiment, the phase shifter module is further configured to tune an amplitude of the optical signal such that the first and the second components of the phase-matched optical signal are combined to form the phase-matched optical signal.

In an embodiment, the first and the second components of the phase-matched optical signal are received at first and second photodiodes of the photodiode module, and the first and second photodiodes converts the first and the second components of the phase-matched optical signal into first and second components of the electrical signal, where the electrical component further includes an amplitude controller configured to tune an amplitude of the converted first and second components of the electric signal such that the first and second electrical components are combined.

In an embodiment, the electrical component further includes: a transimpedance amplifier coupled between the photodiode module and the clock data recovery module, the transimpedance amplifier configured to generate a voltage from the electrical signal, where the measured clock is recovered from the generated voltage, where the generated voltage is configured to bias an electrical circuit in the electrical component.

Another aspect of the present disclosure pertains to a silicon photonics integrated circuit. The circuit includes a polarization splitting grating coupler (PSGC) configured to receive an optical signal and split the optical signal into a first polarization component and a second polarization component; a phase controller coupled to the PSGC, the phase controller configured to tune the split optical signal such that the first and the second polarization components are in phase; a dual-port photodiode coupled to the phase controller, where the dual-port photodiode receives the first and the second polarization components, and the dual-port photodiode converts the first and second polarization components into a combined electrical signal; and an amplitude controller coupled to the dual-port photodiode, the amplitude controller configured to tune an amplitude of the combined electrical signal.

In an embodiment, dual-port photodiode includes: a doped silicon waveguide having a first end and a second end, the first end for receiving the first polarization component and the second end for receiving the second polarization component; and a germanium layer over the doped silicon waveguide and disposed laterally between the first end and the second end, where when the germanium layer is biased, the germanium layer converts the first polarization component and the second polarization component into the combined electrical signal.

In an embodiment, the circuit further includes a first micro ring resonator (MRR) coupled between the PSGC and the phase controller to tune the first polarization component of the optical signal to a first operating wavelength; and a second micro ring resonator (MRR) coupled between the PSGC and the phase controller to tune the second polarization component of the optical signal to the first operating wavelength. The dual-port photodiode receives the first and the second polarization components of the optical signal at the first operating wavelength.

In an embodiment, the phase controller is a first phase controller, the circuit further includes: a second phase controller coupled to the PSGC, the second phase controller also configured to tune the split optical signal such that the first and the second polarization components are in phase; a third micro ring resonator (MRR) coupled between the PSGC and the second phase controller to tune the first polarization component of the optical signal to a second operating wavelength; and a fourth MRR coupled between the PSGC and the second phase controller to tune the second polarization component of the optical signal to the second operating wavelength, where the first and the second operating wavelengths are different.

The details of the method and device of the present disclosure are described in the attached drawings. The foregoing outlines features of several embodiments so that those of ordinary skill in the art may better understand the aspects of the present disclosure. Those of ordinary skill in the art should appreciate that they may readily use the present disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A silicon photonics integrated circuit, comprising:
a polarization splitting grating coupler (PSGC) configured to receive an optical signal and split the optical signal into two polarization components;
a phase controller coupled to the PSGC, the phase controller configured to tune the split optical signal such that the two polarization components are in phase;
a first and a second photodiode coupled to the phase controller, wherein the first photodiode receives a first component of the two polarization components and the second photodiode receives a second component of the two polarization components, and the first and second photodiodes converts the first and second components into first and second electrical signals, respectively; and
an amplitude controller coupled to the first and the second photodiodes, the amplitude controller configured to add the first and the second electrical signals to output a combined electrical signal.

2. The silicon photonics integrated circuit of claim 1, further comprising a feedback circuit, the feedback circuit including:
a pulse generator to provide a reference clock of the optical signal;
a clock data recovery circuit to recover a clock of the combined electrical signal; and
a comparator coupled to the phase controller, the comparator configured to compare the clock of the combined electrical signal with the reference clock, wherein the comparator transmits a control signal to the phase controller to control the tuning of the split optical signal based on the comparison.

3. The silicon photonics integrated circuit of claim 1, wherein the two polarization components include a transverse electric (TE) component and a transverse magnetic (TM) component, and the TM component is converted into a second TE component before the phase controller tunes the split optical signal.

4. The silicon photonics integrated circuit of claim 1, wherein the phase controller is implemented by an optical interference circuit that use one or more Mach-Zehnder interferometers (MZIs).

5. The silicon photonics integrated circuit of claim 1, wherein the first and second electrical signals are first and second electrical currents, and the amplitude controller includes:
a current adder that adds the first and second electrical currents to output a combined current; and
a transimpedance amplifier to convert the combined current into a combined voltage.

6. The silicon photonics integrated circuit of claim 1, wherein the first and second electrical signals are first and second electrical currents, and the amplitude controller includes:
a first and a second transimpedance amplifier to convert the first and the second electrical currents into a first and a second voltage; and
a voltage adder that adds the first and second voltages to output a combined voltage.

7. The silicon photonics integrated circuit of claim 1, further comprising:
a first micro ring resonator (MRR) coupled between the PSGC and the phase controller, wherein the first MRR receives the first component of the two polarization components to tune the first component to a first operating wavelength; and
a second MRR coupled between the PSGC and the phase controller, wherein the second MRR receives the second component of the two polarization components to tune the second component to the first operating wavelength,
wherein the first photodiode receives the first component of the two polarization components at the first operating wavelength, and the second photodiode receives the second component of the two polarization components at the first operating wavelength.

8. The silicon photonics integrated circuit of claim 7, wherein the phase controller is a first phase controller, further comprising:
a second phase controller coupled to the PSGC, the second phase controller also configured to tune the split optical signal such that the two polarization components are in phase;
a third micro ring resonator (MRR) coupled between the PSGC and the second phase controller, wherein the third MRR receives the first component of the two polarization components to tune the first component of the split polarization to a second operating wavelength; and
a fourth MRR coupled between the PSGC and the second phase controller, wherein the fourth MRR receives the second component of the two polarization components to tune the second component of the two polarization components to the second operating wavelength, wherein the first and the second operating wavelengths are different.

9. The silicon photonics integrated circuit of claim 8, further comprising:
a third and a fourth photodiode coupled to the second phase controller, wherein the third photodiode receives the first component of the two polarization components at the second operating wavelength and the fourth photodiode receives the second component of the two polarization components at the second operating wavelength, and the third and fourth photodiodes converts the first and second components at the second operating wavelength into third and fourth electrical signals, respectively.

10. The silicon photonics integrated circuit of claim 1, wherein the first photodiode is a single-port photodiode, and the first photodiode includes:
a first doped silicon waveguide for receiving the first component of the two polarization components; and
a first germanium layer over the first doped silicon waveguide, wherein when the first germanium layer is biased, the first germanium layer converts the first component of the two polarization components into the first electrical signal.

11. The silicon photonics integrated circuit of claim 10, wherein the second photodiode is a single-port photodiode, and the second photodiode includes:
a second doped silicon waveguide for receiving the second component of the two polarization components; and
a second germanium layer over the second doped silicon waveguide, wherein when the second germanium layer is biased, the second germanium layer converts the second component of the two polarization components into the second electrical signal.

12. A silicon photonics integrated circuit, comprising:
an optical component having:
a beamsplitter configured split an optical signal into a first component and a second component,
a phase shifter module configured to tune a phase mismatch between the first and the second components of the optical signal, thereby forming a phase-matched optical signal, and
a photodiode module configured to convert the phase-matched optical signal into an electrical signal; and
an electrical component having:
a clock data recovery module configured to recover a measured clock of the electrical signal, and
a comparator coupled to the clock data recovery module, the comparator compares the recovered measured clock with a reference clock to generate a control signal feeding back to the phase shifter module.

13. The silicon photonics integrated circuit of claim 12, wherein the control signal changes an input bias voltage of the phase shifter module.

14. The silicon photonics integrated circuit of claim 12, wherein the phase shifter module is further configured to tune an amplitude of the optical signal such that the first and the second components of the phase-matched optical signal are combined to form the phase-matched optical signal.

15. The silicon photonics integrated circuit of claim 12, wherein the first and the second components of the phase-matched optical signal are received at first and second photodiodes of the photodiode module, and the first and second photodiodes converts the first and the second components of the phase-matched optical signal into first and second components of the electrical signal,
wherein the electrical component further includes an amplitude controller configured to tune an amplitude of the converted first and second components of the electric signal such that the first and second electrical components are combined.

16. The silicon photonics integrated circuit of claim 12, wherein the electrical component further includes:
a transimpedance amplifier coupled between the photodiode module and the clock data recovery module, the transimpedance amplifier configured to generate a voltage from the electrical signal,
wherein the measured clock is recovered from the generated voltage,
wherein the generated voltage is configured to bias an electrical circuit in the electrical component.

17. A silicon photonics integrated circuit, comprising:
a polarization splitting grating coupler (PSGC) configured to receive an optical signal and split the optical signal into a first polarization component and a second polarization component;
a phase controller coupled to the PSGC, the phase controller configured to tune the split optical signal such that the first and the second polarization components are in phase;
a dual-port photodiode coupled to the phase controller, wherein the dual-port photodiode receives the first and the second polarization components, and the dual-port photodiode converts the first and second polarization components into a combined electrical signal; and
an amplitude controller coupled to the dual-port photodiode, the amplitude controller configured to tune an amplitude of the combined electrical signal.

18. The silicon photonics integrated circuit of claim 17, wherein dual-port photodiode includes:
a doped silicon waveguide having a first end and a second end, the first end for receiving the first polarization component and the second end for receiving the second polarization component; and
a germanium layer over the doped silicon waveguide and disposed laterally between the first end and the second end, wherein when the germanium layer is biased, the germanium layer converts the first polarization component and the second polarization component into the combined electrical signal.

19. The silicon photonics integrated circuit of claim 17, further comprising:
a first micro ring resonator (MRR) coupled between the PSGC and the phase controller to tune the first polarization component of the optical signal to a first operating wavelength; and
a second micro ring resonator (MRR) coupled between the PSGC and the phase controller to tune the second polarization component of the optical signal to the first operating wavelength
wherein the dual-port photodiode receives the first and the second polarization components of the optical signal at the first operating wavelength.

20. The silicon photonics integrated circuit of claim 19, wherein the phase controller is a first phase controller, further comprising:
a second phase controller coupled to the PSGC, the second phase controller also configured to tune the split optical signal such that the first and the second polarization components are in phase;
a third micro ring resonator (MRR) coupled between the PSGC and the second phase controller to tune the first polarization component of the optical signal to a second operating wavelength; and
a fourth MRR coupled between the PSGC and the second phase controller to tune the second polarization component of the optical signal to the second operating wavelength, wherein the first and the second operating wavelengths are different.
